(19) United States
(12) Patent Application Publication
(10) Pub. No.: US 2013/0011017 A1
(43) Pub. Date: Jan. 10, 2013

(54) METHOD OF OBTAINING SPATIAL IMAGES ON DEMAND

(75) Inventors: Seung Hun OH, Gwangju (KR); Seok Kap Ko, Gwangju (KR); Sim Kwon Yoon, Gwangju (KR); Byung Tak Lee, Gyeonggi-do (KR); Young Sun Kim, Daejeon (KR)

(73) Assignee: Electronics and Telecommunications Research Institute, Daejon (KR)

(21) Appl. No.: 13/529,346

(22) Filed: Jun. 21, 2012

(30) Foreign Application Priority Data
Jul. 5, 2011 (KR) 10-2011-0066393
May 4, 2012 (KR) 10-2012-0047226

(51) Int. Cl. G06K 9/00; H04N 7/18; G06K 9/34

(52) U.S. Cl. 382/106; 382/173; 348/143; 348/E07.085

(57) ABSTRACT

Provided is a method of obtaining spatial images on demand. The server segments a spatial image into a plurality of regions to detect an isolated region whose continuity with peripheral regions is less than a threshold value, generates geographic information corresponding to the detected isolated region, and generates a capture request message including the generated geographic information. In addition, the capture request message may be transmitted to at least one terminal using unicast scheme, a multicast scheme, an anycast scheme, or a broadcast scheme. The capture request message may comprise a capture condition value such as a capture direction, a capture angle, a capture time, a zoom information and an exposure value. At least one terminal which meets the capture condition value within the capture request message transmits a captured image to the server.

### CLAIM FOR PRIORITY

This application claims priority to Korean Patent Application No. 10-2011-0066393 filed on Jul. 5, 2011 and No. 10-2012-0047226 filed on May 4, 2012 in the Korean Intellectual Property Office (KIPO), the entire contents of which are hereby incorporated by reference.

### BACKGROUND

1. Technical Field

Example embodiments of the present invention relate in general to a method of obtaining spatial images, and more specifically to a method of obtaining spatial images on demand which continuously updates collected spatial images.

2. Related Art

With advancements in image technology, a service that synthesizes many images to generate and provide a relatively larger image is being proposed. As a representative service, there is a roadview service. The roadview service enables a user to view an image of an actual road on a web browser, and thus collecting many appropriate images is the core competence of the service.

Technology that provides the service includes technology that captures an image of a road with a camera and transfers the captured image to a central server, and technology that synthesizes images collected by a server to generate a large image corresponding to an actual road and posts the large image in connection with a map on the Web. Representative service providers are Daum Communication, Naver, etc.

For the service, technology to capture images of roads is important above all. Currently, special vehicles with expensive camera devices mounted thereon capture images of roads. However, due to restrictions of equipment and manpower, the method has limitations in that an update period is very slow and it is difficult to reflect images of narrow spaces such as alleys.

To overcome these limitations, users can personally capture and collect images and synthesize the captured images so that services such as roadview can be provided. In such a method, however, since images captured by users are irregularly posted at random, images are omitted, and thus high-quality service cannot be provided and load can be applied to network or a storage space due to the transfer of duplicate images.

### SUMMARY

Accordingly, example embodiments of the present invention are provided to substantially obviate one or more problems due to limitations and disadvantages of the related art.

Example embodiments of the present invention provide a method of obtaining spatial images on demand.

In some example embodiments, an image obtaining method performed in a server includes: segmenting a spatial image into a plurality of regions to detect an isolated region whose continuity with peripheral regions is less than a threshold value; generating geographic information corresponding to the detected isolated region; and generating a capture request message including the generated geographic information.

Isolated regions may include at least one of: a region in which a portion of the spatial image has been omitted; a region whose quality is less than a threshold value compared to the peripheral regions in the spatial image; and a region that was captured a certain time or more prior to the peripheral regions.

The detection of the isolated region may be performed at predetermined intervals.

The image obtaining method may further include transmitting the generated capture request message to a terminal.

The capture request message may further include a capture parameter value that includes at least one of a capture direction, a capture time, and a capture condition.

The capture request message may be transmitted by a unicast scheme, a multicast scheme, an anycast scheme, or a broadcast scheme.

The image obtaining method may further include receiving an image captured in response to the capture request message from a terminal that received the capture request message, a capturing apparatus of the terminal being disposed within a range where it is capable of capturing a position corresponding to geographic information included in the capture request message.

In other example embodiments, an image obtaining method including an image collecting method performed in a capturing apparatus includes: receiving a capture request message including geographic information from a server; and determining whether a position corresponding to the geographic information is within a range possible to capture by the capturing apparatus.

The capturing apparatus may be attached to a terminal which is disposed in a moving means, and the range possible to capture by the capturing apparatus may include a capture range over a distance by which the moving means moves in a predetermined time.

When it is determined that the capturing apparatus is within the range possible to capture, the image obtaining method may further include: capturing a position corresponding to the geographic information; and transmitting the captured image to a server.

The server may segment a synthesized spatial image into a plurality of regions to detect an isolated region whose continuity with peripheral regions is less than a threshold value, and generate the capture request message on the basis of geographic information corresponding to the detected isolated region.

The capture request message may further include a capture parameter value that includes at least one of a capture direction, a capture time, and a capture condition.

In still other example embodiments, an image obtaining method performed in a first terminal includes: receiving a capture request message for road conditions at a specific position from a second terminal; capturing the road conditions for the specific position, when the road conditions at the specific position are within a range possible to capture by a capturing apparatus of the first terminal; and transmitting the captured image to the second terminal.

The first terminal may be disposed in a moving means, and the range possible to capture by the capturing apparatus of the first terminal may include a capture range over a distance by which the moving means moves in a predetermined time.

The capture request message may include direction information and position information on the specific position.

The capture request message may be transmitted by a broadcast scheme.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram schematically illustrating a system for obtaining spatial images according to an example embodiment of the present invention;

FIG. 2 is a flowchart illustrating an operation of obtaining spatial images in a server according to an example embodiment of the present invention;

FIG. 3 is a block diagram illustrating a configuration of an apparatus for obtaining spatial images in a server according to an example embodiment of the present invention;

FIG. 4 is a flowchart illustrating an operation of obtaining spatial images in a capturing apparatus according to an example embodiment of the present invention;

FIG. 5 is a conceptual diagram illustrating a configuration of a capturing apparatus for obtaining spatial images according to an example embodiment of the present invention;

FIG. 6 is a conceptual diagram illustrating an operation of obtaining spatial images according to a request between vehicles, according to another example embodiment of the present invention; and

FIG. 7 is a flowchart illustrating an operation of obtaining spatial images according to a request between vehicles, according to another example embodiment of the present invention.

### DESCRIPTION OF EXAMPLE EMBODIMENTS

The invention may have diverse modified embodiments, and thus, example embodiments are illustrated in the drawings and are described in the detailed description of the invention. However, this does not limit the invention within specific embodiments and it should be understood that the invention covers all the modifications, equivalents, and replacements within the idea and technical scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used Here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used Here, the singular forms “a”, “an” and “the” are intended to include the plural forms as well, unless the context clearly indicates otherwise. It will be further understood that the terms “comprises”, “comprising,”, “includes” and/or “including”, when used Here, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in detail with reference to the accompanying drawings. To describe the example embodiments clearly and concisely, the same reference numerals are used to denote elements when they reappear in different drawings, and descriptions of elements are not repeated.

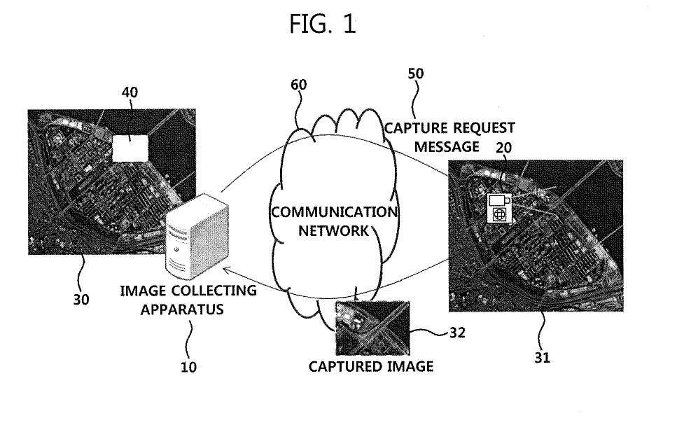

FIG. 1 is a conceptual diagram schematically illustrating a system for obtaining spatial images according to an example embodiment of the present invention.

Referring to FIG. 1, the system for obtaining spatial images according to an example embodiment of the present invention includes an image collecting apparatus 10 including a spatial image 30, and a terminal that obtains spatial image data and supplies the spatial image data to the image collecting apparatus 10.

The image collecting apparatus 10 stores the image 30, which is generated by synthesizing a plurality of relevant images such as photos of nearby places. Here, the synthesized image 30 may not be perfect; it may be missing a specific area 40 that was omitted and it may have a portion of poor quality. Such portions are required to be updated quickly. For example, when a capturing apparatus 20 for each area captures a corresponding area 31 and transmits a captured image 32, the image 32 may be omitted and not transmitted, or it may not be perfectly synthesized.

To overcome such limitations, the image collecting apparatus 10 analyzes the spatial image 30 and compares an empty region due to omission with a peripheral region, thereby extracting an inconsistent region (for example, a region 40 of relatively poor quality). The image collecting apparatus 10 extracts a parameter, which is configured with geographic information, capture information, time information, and the other sensor information, to generate a capture request message 50, and transmits the capture request message 50 to the capturing apparatus 20. Here, the spatial image may include a digital live image, a digital live video, a laser scan image, a Lidar scan image, and an ultrasonic scan image.

When the capturing apparatus 20 has received the capture request message 50 from the image collecting apparatus 10, the capturing apparatus 20 extracts geographic information and a parameter which are included in the message 50, captures a corresponding area on the basis of the extracted information and parameter, and transmits the captured image 32 to the image collecting apparatus 10. Here, the image collecting apparatus 10 may be a server that provides an image service. Also, the capturing apparatus 20 may be navigation equipment or a black box that is mounted in a moving means such as a vehicle, a smart phone, measurement equipment mounted on public transportation equipment, or measurement equipment mounted on airplanes.

Geographic information included in the capture request message 50 may include latitude, longitude, and altitude that correspond to position information. The parameter may include an capture angle, zoom information, an exposure value, and sensor information (capable of expressing other ambient conditions) such as time information and temperature information, which are necessary for capturing an image.

The capture request message 50 may be transferred to the capturing apparatus 20 over a data communication network 60, which may include all wired/wireless networks that are used currently. For example, the data communication network 60 may include the Internet, a wireless LAN, a 3G network, WiMax, etc.

Moreover, the capture request message 50 may be transmitted to the capturing apparatus 20 by a scheme such as multicast, anycast, broadcast, and unicast. That is, as illustrated in FIG. 1, the capture request message 50 may be transferred to the specific capturing apparatus 20 by unicast, or transferred to a plurality of capturing apparatuses by a scheme such as multicast, anycast, and broadcast. A capturing apparatus receiving the message 50 may capture a corresponding area and transmit a captured image to the image collecting apparatus 10 when geographic information and a parameter included in the message 50 correspond to an environment in which the capturing apparatus is disposed.

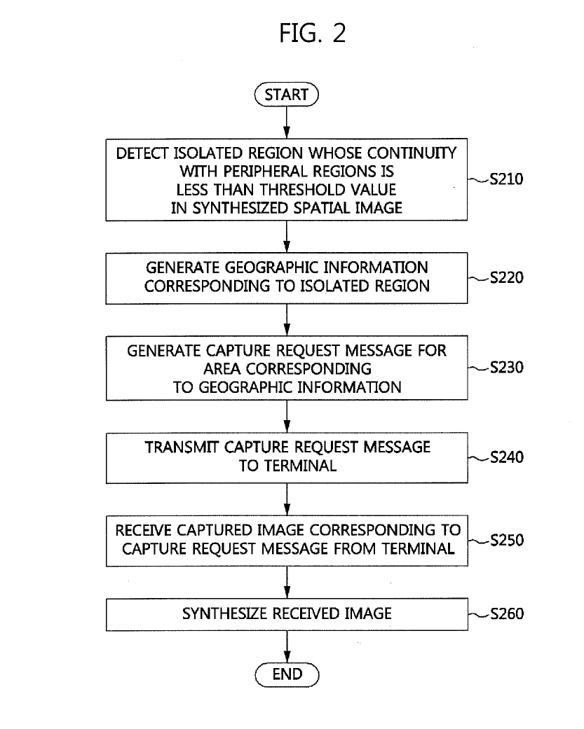

FIG. 2 is a flowchart illustrating an operation of obtaining spatial images in a server according to an example embodiment of the present invention.

Referring to FIG. 2, the operation of obtaining spatial images in the server according to an example embodiment of the present invention includes an isolated region detecting step S210, a geographic information generating step S220, a capture request message generating step S230, a message transmitting step S240, an image receiving step S250, and an image synthesizing step S260.

Each step of the operation of obtaining spatial images in the server according to an example embodiment of the present invention will be described with reference to FIG. 2 as follows.

The isolated region detecting step S210 may be a step that segments a spatial image into a plurality of regions, and detects an isolated region whose continuity with peripheral regions is less than a threshold value. That is, the isolated region may be detected by analyzing the spatial image to compare a predetermined region with peripheral regions, and it may include an inconsistent region, for example, a region in which a portion of an image is omitted, a region whose quality is less than a threshold value compared to the peripheral region, and a region that was captured a predetermined time or more prior to the peripheral region. Also, detection of isolated regions may be performed at predetermined intervals and updated continuously.

The geographic information generating step S220 may be a step of generating geographic information corresponding to the isolated region detected in the isolated region detecting step S210. For example, the geographic information may include latitude, longitude, and altitude that correspond to the isolated region.

The capture request message generating step S230 may be a step of generating a capture request message for an area corresponding to the generated geographic information. Here, the generated capture request message may include a parameter value that is configured with geographic information, photographic information, time information, and the other sensor information.

The message transmitting step S240 may be a step of transmitting the generated capture request message to a terminal. Here, as described above, the capture request message may be transmitted by a unicast scheme in which a message is transmitted to a specific designated terminal, or a multicast, anycast, or broadcast scheme in which a message is transmitted to a plurality of undesignated terminals.

The image receiving step S250 may be a step of receiving an image captured in response to the capture request message from a terminal which has received the capture request message. Here, a capturing apparatus of the terminal may be disposed within a range enabling the capture of a position corresponding to the geographic information included in the capture request message. The received image is synthesized with the existing spatial image in step S260, thereby newly updating an image.

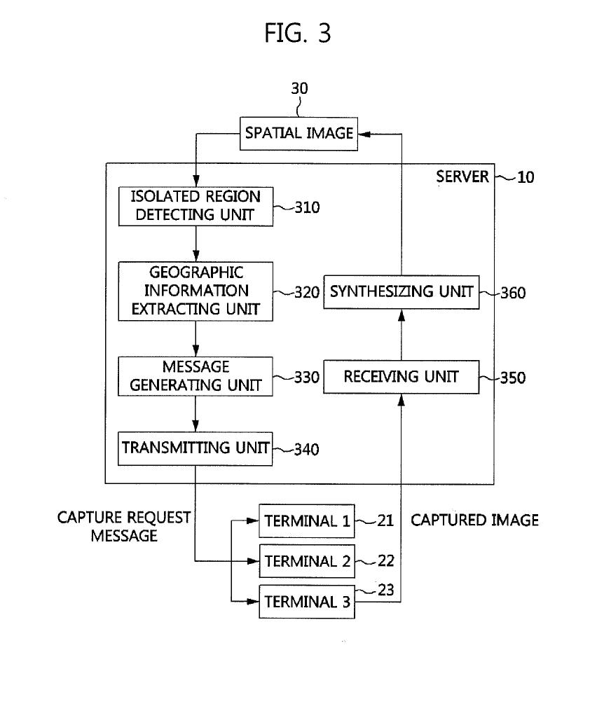

FIG. 3 is a block diagram illustrating a configuration of an apparatus for obtaining spatial images in a server according to an example embodiment of the present invention.

Referring to FIG. 3, the apparatus for obtaining spatial images in the server according to an example embodiment of the present invention includes an isolated region detecting unit 310, a geographic information extracting unit 320, a message generating unit 330, a transmitting unit 340, a receiving unit 350, and a synthesizing unit 360.

Each element of the apparatus for obtaining spatial images in the server according to an example embodiment of the present invention will be described with reference to FIG. 3 as follows.

The isolated region detecting unit 310 may segment the spatial image 30 (which is stored in an image storage unit (not shown)) into a plurality of regions, and detect an isolated region whose continuity with peripheral regions is less than a threshold value. That is, by analyzing the spatial image 30 at intervals, the isolated region detecting unit 310 detects regions of poor quality and omitted regions. For example, isolated regions may include a region in which a portion of an image is omitted, a region whose quality is less than a threshold value compared to the peripheral region, and a region that was captured a predetermined time or more prior to the peripheral region. Also, detection of isolated regions may be performed at predetermined intervals and updated continuously.

The geographic information extracting unit 320 may extract geographic information corresponding to an isolated region detected by the isolated region detecting unit 310. That is, the geographic information extracting unit 320 may extract position information (latitude, longitude, altitude, etc.) from an actual geographic space on the basis of information on the isolated region, and calculate a parameter value that is configured with capture position information, capture angle information, exposure information, time information and the like that are used for obtaining an image corresponding to the extracted position information. Here, the parameter value may include other sensing information, for example, temperature, humidity, etc.

The message generating unit 330 may generate a capture request message for an area corresponding to the generated geographic information. Here, the generated capture request message may include a parameter value that is configured with geographic information, photographic information, time information, and the other sensor information.

The transmitting unit 340 may transmit the generated capture request message to a terminal. Here, the capture request message may be transmitted by a unicast scheme in which a message is transmitted to a specific designated terminal, or a multicast, anycast, or broadcast scheme in which a message is transmitted to a plurality of undesignated terminals 21 to 23.

The receiving unit 350 may receive an image captured in response to the capture request message from one or some of terminals that received the capture request message. Here, a capturing apparatus of each terminal may be disposed within a range enabling the capture of a position corresponding to the geographic information included in the capture request message.

The synthesizing unit 360 may synthesize the received image with the existing spatial image, thereby generating a newly updated image to be stored in the image storage unit.

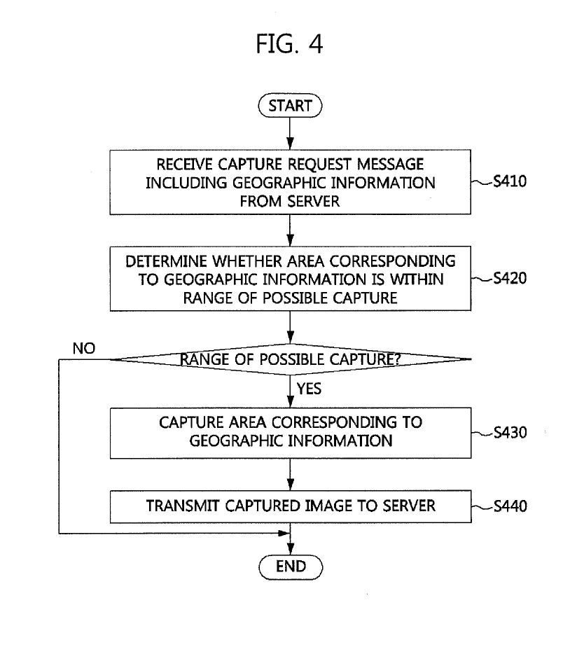

FIG. 4 is a flowchart illustrating an operation of obtaining spatial images in a capturing apparatus according to an example embodiment of the present invention.

Referring to FIG. 4, the operation of obtaining spatial images in the capturing apparatus according to an example embodiment of the present invention includes a capture request message receiving step S410, a capture feasibility determining step S420, a capturing step S430, and an image transmitting step S440.

Each step of the operation of obtaining spatial images in the capturing apparatus according to an example embodiment of the present invention will be described with reference to FIG. 2 as follows.

The capture request message receiving step S410 may be a step of receiving a capture request message including geographic information from a server.

The capture feasibility determining step S420 may be a step of determining whether a position corresponding to geographic information included in the received message is within a range possible to capture by the capturing apparatus. The capturing apparatus may be attached to a terminal that is disposed in a moving means such as a vehicle, carried by a user, or fixed to a specific position. When the capturing apparatus is disposed in a moving means such as a vehicle, a range possible to capture by the capturing apparatus may include a capture range over a distance by which the vehicle moves in a predetermined time. That is, if the vehicle moves for a predetermined time and then arrives at a position from which it can capture the position corresponding to the geographic information, the capture range may thus be expanded by considering a moved distance or time as well as a capture range when the capturing apparatus is fixed.

The capturing step S430 may be a step that captures a position corresponding to the geographic information included in the received message, when the capturing apparatus is determined to be disposed within the range possible to capture the position.

As described above, when the capturing apparatus is disposed in an operable vehicle (for example, in a type such as a navigator, a black box, a smart phone, etc.), the capturing apparatus captures an image while moving for a predetermined time, thereby obtaining a spatial image corresponding to the geographic information included in the capture request message.

The image transmitting step S440 may be a step of transmitting a captured image to the server in response to the received capture request message.

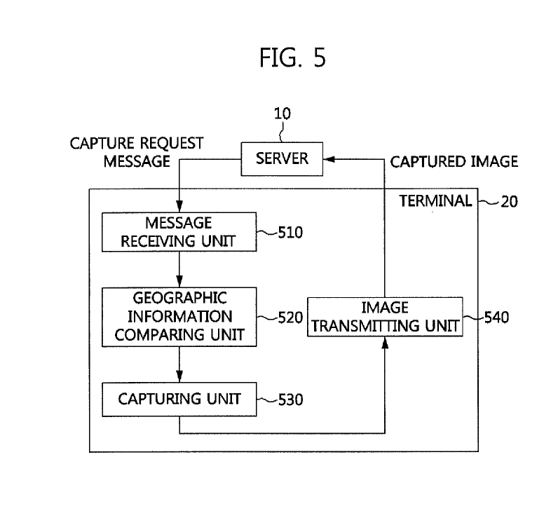

FIG. 5 is a conceptual diagram illustrating a configuration of a capturing apparatus for obtaining spatial images according to an example embodiment of the present invention.

Referring to FIG. 5, the capturing apparatus according to an example embodiment of the present invention includes a message receiving unit 510, a geographic information comparing unit 520, a capturing unit 530, and an image transmitting unit 540.

The capturing apparatus according to an example embodiment of the present invention will be described with reference to FIG. 5 as follows.

The message receiving unit 510 may receive a capture request message including geographic information from a server.

The geographic information comparing unit 520 may determine whether a position corresponding to the geographic information included in the received message is within a range possible to capture by the capturing apparatus. The capturing apparatus may be attached to a terminal 20 that is disposed in a vehicle, in which case a range possible to capture by the capturing apparatus may include a capture range over a distance by which the vehicle moves in a predetermined time.

The capturing unit 530 may capture a position corresponding to the geographic information included in the received message when the capturing apparatus is within the range possible to capture the position.

The image transmitting unit 540 may transmit a captured image to a server 10 in response to the received capture request message.

A case in which a capture request between vehicles is exchanged will be described as another example embodiment according to the present invention. For example, when vehicles move slowly or do not move due to traffic congestion on a road, it can be useful to request an image of road conditions from a vehicle further down the road or from a vehicle travelling on another road.

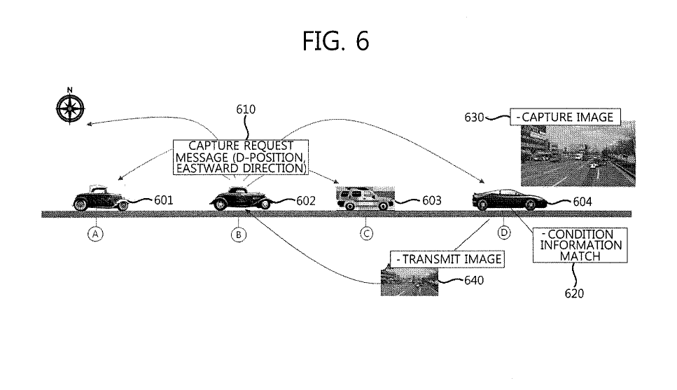

FIG. 6 is a conceptual diagram illustrating an operation of obtaining spatial images according to a request between vehicles, according to another example embodiment of the present invention.

Referring to FIG. 6, in a case where a vehicle 602 disposed at a position B wishes information on forward road conditions, when the vehicle 602 wants to view an image that is captured in an eastward direction corresponding to the front from a position D, the vehicle 602 may generate a parameter (position D, eastward direction) corresponding thereto and transmit the parameter according to a broadcast scheme in operation 610. All vehicles 601 to 604 on the road and capable of communication check a message of the parameter to determine whether the received parameter corresponds to their own conditions. In this case, a communication scheme may be a communication scheme between vehicles, for example, ad-hoc wireless communication, wireless mesh communication, 3 G communication, or WiMax communication.

In the present embodiment, only the vehicle 604 disposed at the position D matches with conditions included in the parameter in operation 620. Therefore, the vehicle 604 captures an image corresponding to a received capture request message in operation 630, and transfers the captured image to the vehicle 602 disposed at a position B in operation 640.

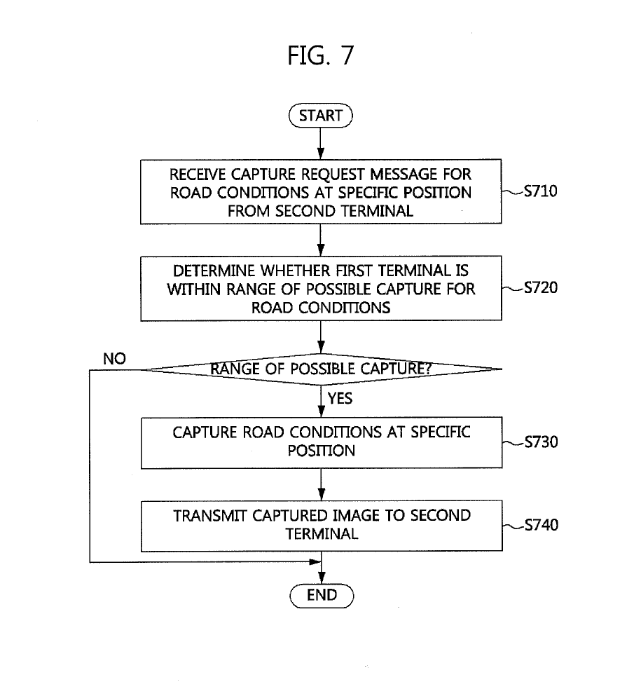

FIG. 7 is a flowchart illustrating an operation of obtaining spatial images according to a request between vehicles, according to another example embodiment of the present invention.

Referring to FIG. 7, the operation of obtaining spatial images according to a request between vehicles, according to another example embodiment of the present invention includes a message receiving step S710, a capture feasibility determining step S720, a capturing step S730, and an image transmitting step S740.

Each step of operation of obtaining spatial images according to a request between vehicles, according to another example embodiment of the present invention, will be described with reference to FIG. 7 as follows.

The message receiving step S710 may be a step in which a first terminal receives a capture request message for road conditions at a specific position from a second terminal. Here, the capture request message may include position information and direction information on the specific position.

The capture feasibility determining step S720 may be a step of determining whether the road conditions at the specific position are within a range possible to capture by a capturing apparatus of the first terminal. Here, the range possible to capture by the capturing apparatus of the first terminal may include a capture range over a distance by which the vehicle moves in a predetermined time.

The capturing step S730 may be a step of capturing the road conditions at the specific position when it is determined that the road conditions at the specific position are within the range possible to capture by the first terminal. The image transmitting step S740 may be a step of transmitting a captured image.

In using the method of obtaining spatial images on demand according to the example embodiments of the present invention, a region to be updated is extracted from an image, a capture request message is transmitted to a terminal, a corresponding captured image is received from the terminal, an image is updated by reflecting the received image Here, and thus a more accurate synthesized image can be provided by using a service such as roadview, thereby increasing service quality. Also, according to the example embodiments of the present invention, a map service based on an image can be updated at shorter intervals.

While the example embodiments of the present invention and their advantages have been described in detail, it should be understood that various changes, substitutions and alterations may be made herein without departing from the scope of the invention.

What is claimed is:

1. An image obtaining method performed in a server, the image obtaining method comprising:
segmenting a spatial image into a plurality of regions to detect an isolated region whose continuity with peripheral regions is less than a threshold value;
generating geographic information corresponding to the detected isolated region; and
generating a capture request message comprising the generated geographic information.

2. The image obtaining method of claim 1, wherein the isolated region comprises at least one of: a region in which a portion of the spatial image has been omitted; a region whose quality is less than a threshold value compared to the peripheral regions in the spatial image; and a region that was captured a certain time or more prior to the peripheral regions.

3. The image obtaining method of claim 1, wherein the detection of the isolated region is performed at predetermined intervals.

4. The image obtaining method of claim 1, further comprising transmitting the generated capture request message to at least one terminal by using at least one scheme of a unicast scheme, a multicast scheme, an anycast scheme and a broadcast scheme.

5. The image obtaining method of claim 1, wherein the capture request message further comprises a capture condition value, the value comprising at least one of a capture direction, a capture angle, a capture time, a zoom information and an exposure value.

6. The image obtaining method of claim 5, further comprising receiving an image captured in response to the capture request message from the at least one terminal that received the capture request message, a capturing apparatus of the at least one terminal being disposed within a range where it is capable of capturing a position corresponding to geographic information comprised in the capture request message.

7. The image obtaining method of claim 6, wherein the capturing apparatus of the at least one terminal satisfies the capture condition value of the capture request message.

8. An image obtaining method including an image collecting method performed in a capturing apparatus, the method comprising:
receiving a capture request message comprising geographic information from a server; and
determining whether a position corresponding to the geographic information is within a range possible to capture by the capturing apparatus.

9. The image obtaining method of claim 8, wherein,
the capturing apparatus is attached to a terminal which is disposed in a moving means, and
the range possible to capture by the capturing apparatus comprises a capture range over a distance by which the moving means moves in a predetermined time.

10. The image obtaining method of claim 8, further comprising:
when it is determined that the capturing apparatus is within the range possible to capture,
capturing a position corresponding to the geographic information; and
transmitting the captured image to a server.

11. The image obtaining method of claim 8, wherein the server segments a synthesized spatial image into a plurality of regions to detect an isolated region whose continuity with peripheral regions is less than a threshold value, and generates the capture request message on the basis of geographic information corresponding to the detected isolated region.

12. The image obtaining method of claim 8, wherein the capture request message further comprises a capture condition value, the value comprising at least one of a capture direction, a capture angle, a capture time, a zoom information and an exposure value.

13. The image obtaining method of claim 12, wherein the capturing apparatus satisfies the capture condition value of the capture request message

14. An image obtaining method performed in a first terminal, the method comprising:
receiving a capture request message for road conditions at a specific position from a second terminal;
capturing the road conditions for the specific position, when a capture determination condition included in the capture request message is satisfied by a capturing apparatus of the first terminal; and
transmitting the captured image to the second terminal.

15. The image obtaining method of claim 14, when a capture determination condition includes that the road conditions at the specific position are within a range possible to capture by a capturing apparatus of the first terminal.

16. The image obtaining method of claim 15, wherein,
the first terminal is disposed in a moving means, and
the range possible to capture by the capturing apparatus of the first terminal comprises a capture range over a distance by which the moving means moves in a predetermined time.

17. The image obtaining method of claim 14, wherein the capture determination condition comprises at least one of a capture direction, a capture angle, a capture time, a zoom information and an exposure value which are required to capture the road conditions for the specific position.

18. The image obtaining method of claim 14, wherein the capture request message is transmitted by a broadcast scheme.
